(19) United States
(12) Patent Application Publication
(10) Pub. No.: US 2010/0309623 A1
(43) Pub. Date: Dec. 9, 2010

(54) INDUSTRIAL COMPUTER

(76) Inventors: Mei-Yin Yeh, TAIPEI CITY (TW); Yi-Chun Tang, TAIPEI CITY (TW); Ho-Ching Huang, TAIPEI CITY (TW); Hui-Chen Wang, TAIPEI CITY (TW); I-Tien Hsieh, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/790,985

(22) Filed: Jun. 1, 2010

(30) Foreign Application Priority Data
Jun. 4, 2009 (TW) 098118620

(51) Int. Cl. G06F 1/20

(52) U.S. Cl. 361/679.48; 361/679.46; 361/679.52; 361/679.54

(57) ABSTRACT

An industrial computer includes a first casing, a second casing, a storage unit, and a heat dissipation unit. The second casing and the first casing form a closed casing, and outside of the second casing has a containing area. The storage unit is disposed in the closed casing, contacts the second casing, and corresponds to the containing area. The heat dissipation unit is disposed at the containing area.

### CROSS-REFERENCE TO RELATED APPLICATIONS

This Non-provisional application claims priority under 35 U.S.C. §119(a) on Patent Application No(s). 098118620 filed in Taiwan, Republic of China on Jun. 4, 2009, the entire contents of which are hereby incorporated by reference.

### BACKGROUND OF THE INVENTION

1. Field of the Invention

This invention relates to a computer and, more particular, to an industrial computer.

2. Description of the Related Art

An industrial computer is a computer which is not used for a general consuming or commercial use. Since the industrial computer is generally used in the demanding environment, the industrial computer often needs to be resistant to a high temperature and a lower temperature, waterproof, dustproof, and with better heat dissipation.

FIG. 1 is a schematic diagram showing a conventional notebook computer 1. The notebook computer 1 includes a display portion 11 and a main body portion 12. The main body portion 12 has an upper casing 121 and a lower casing 122, and a main body (not shown) is disposed between the upper casing 121 and the lower casing 122. In the notebook computer 1, a heat dissipation hole H may be disposed at the lower casing 122 and correspond to the hard disk drive 123 to enhance the heat dissipation of a hard disk drive 123 of a main body.

However, when an environment temperature of the notebook computer 1 is harsh, the heat generated from hard disk drive 123 fails to be effectively dissipated from the heat dissipation hole H. Further, since the heat dissipation hole H fails to achieve a waterproof and dustproof effect, the notebook computer 1 fails to satisfy standard requirements of the industrial computer.

As far as a waterproof and dustproof standard of the industrial computer is considered, a closed casing is for the better casing design of the industrial computer. However, the closed casing may cause a worse heat dissipation and the internal temperature of the casing may increase to cause instability of the whole system. Further, heat generated by internal electronic components such as a central processing unit, a north bridge chip, a memory, a hard disk drive and so on may accumulate in the casing.

### BRIEF SUMMARY OF THE INVENTION

One objective of this invention is to provide an industrial computer capable of improving heat dissipation and satisfying industrial standard requirements.

The embodiment of the invention provides an industrial computer including a first casing, a second casing, a storage unit, and a heat dissipation unit. The second casing and the first casing form a closed casing, and the outside of the second casing has a containing area. The storage unit is disposed in the closed casing, contacts the second casing, and corresponds to the containing area. The heat dissipation unit is disposed at the containing area.

In the embodiment of the invention, the heat dissipation unit may include a heat sink, a heat dissipation fin, a heat dissipation plate, a heat pipe, or a heat dissipation fan.

According to the industrial computer in the embodiment of the invention, the heat dissipation unit corresponds to the storage unit, and the heat dissipation unit may include a heat sink, a heat dissipation fin, a heat dissipation plate, a heat pipe, a heat dissipation fan, or a combination thereof. Therefore, the heat dissipation of the storage unit can be greatly improved by the heat dissipation unit such as a heat dissipation fin or a heat dissipation fan and so on, and a heat dissipation structure such as a heat dissipation hole may be avoided to satisfy industrial standard requirements.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional notebook computer;

FIG. 2A is a schematic diagram showing an industrial computer according to one preferred embodiment of the invention;

FIG. 2B is a sectional schematic diagram showing an industrial computer according to one preferred embodiment of the invention; and

FIG. 3A and FIG. 3B are schematic diagrams showing an industrial computer in different modes according to one preferred embodiment of the invention.

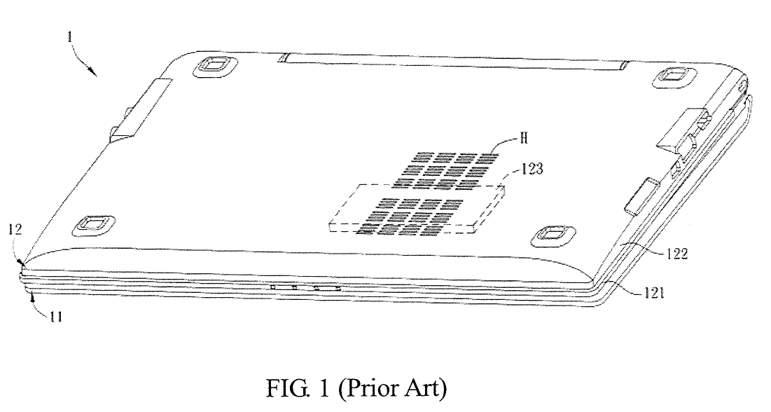

### DETAILED DESCRIPTION OF THE INVENTION

An industrial computer according to one preferred embodiment of the invention is described, and the same element is marked by the same reference number.

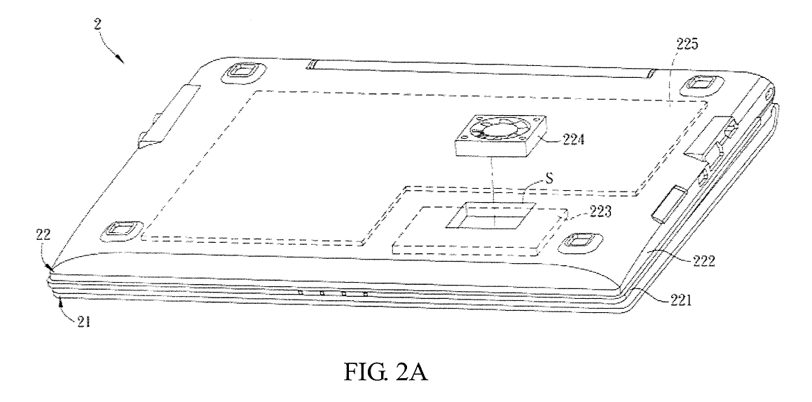

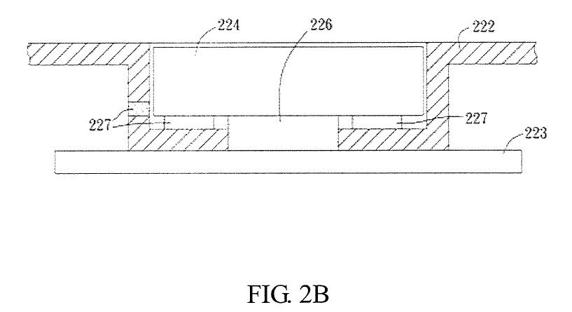

FIG. 2A is a schematic diagram showing an industrial computer 2 according to one preferred embodiment of the invention. FIG. 2B is a sectional schematic diagram showing the industrial computer 2 according to the preferred embodiment of the invention. In FIG. 2B, only a second casing 222, a storage unit 223, and a heat dissipation unit 224 are shown for clear description.

The industrial computer 2 includes a first casing 221, a second casing 222, a storage unit 223, and a heat dissipation unit 224. In addition, the industrial computer 2 may include a display portion 21 and a main body portion 22, and the display portion 21 and the main body portion 22 may be connected with each other via a hinge. The display portion 21 may include a display panel. The first casing 221, the second casing 222, the storage unit 223, and the heat dissipation unit 224 are located at the main body portion 22.

The first casing 221 and the second casing 222 may be made of metal, an alloy, or a high polymer. The second casing 222 and the first casing 221 form a closed casing, and the outside of the second casing 222 has a containing area S.

The storage unit 223 is disposed in the closed casing formed by the first casing 221 and the second casing 222, contacts the second casing 222, and corresponds to the containing area S. The storage unit 223 may be a solid state drive (SSD) or a conventional hard disk drive (HDD).

The heat dissipation unit 224 is disposed at the containing area S. The heat dissipation unit 224 may include a heat sink, a heat dissipation fin, a heat dissipation plate, a heat pipe, or a heat dissipation fan. In the embodiment, the heat dissipation unit 224 includes a heat dissipation fan. However, the invention is not limited thereto.

In addition, in the embodiment, the main body portion 22 may include a main body unit 225 and a thermal pad 226.

The main body unit 225 is disposed in the closed casing formed by the first casing 221 and the second casing 222. The main body unit 225 may include a motherboard, a central processing unit (CPU), a north bridge chip, a south bridge chip, a memory and so on. The components included by the main body unit 225 are not shown in FIG. 2A for clear description.

However, in an actual operation, the main body unit 225 should include the components.

The thermal pad 226 is connected with the storage unit 223 and the heat dissipation unit 224. Certainly, a hole may be disposed at the second casing 222 and corresponds to the storage unit 223, such that the thermal pad 226 can correspond to the hole and be disposed between the storage unit 223 and the heat dissipation unit 224. Thereby, via the thermal pad 226, the heat conducting efficiency can increase to improve the heat dissipation.

Therefore, the heat dissipation unit 224 is disposed at the other side of the second casing 222 and corresponds to the storage unit 223 to dissipate the heat generated by the storage unit 223 to the heat dissipation fan of the heat dissipation unit 224 by the thermal pad 226. Then, the heat dissipation fan of the heat dissipation unit 224 dissipates the heat outside. Thereby, the heat dissipation of the heat dissipation unit 224 for the storage unit 223 is greatly improved, and a heat dissipation structure such as a heat dissipation hole can be avoided. Thus, the industrial computer 2 in the embodiment has a waterproof and dustproof effect to satisfy industrial standard requirements.

Further, the industrial computer 2 may include a plurality of waterproof elements 227 disposed at the second casing 222 or between the second casing 222 and the heat dissipation unit 224. The waterproof elements 227 may be made of rubber or other high polymer materials. Therefore, by disposing the waterproof elements 227 at the hole of the second casing 222 for allowing cables electrically connecting the heat dissipation fan of the heat dissipation unit 224 and the main body unit 225 to pass through or at the space between the second casing 222 and the heat dissipation unit 224. The waterproof and dustproof effect of the main body portion 22 are further improved thus to satisfy the industrial standard requirements of the industrial computer 2.

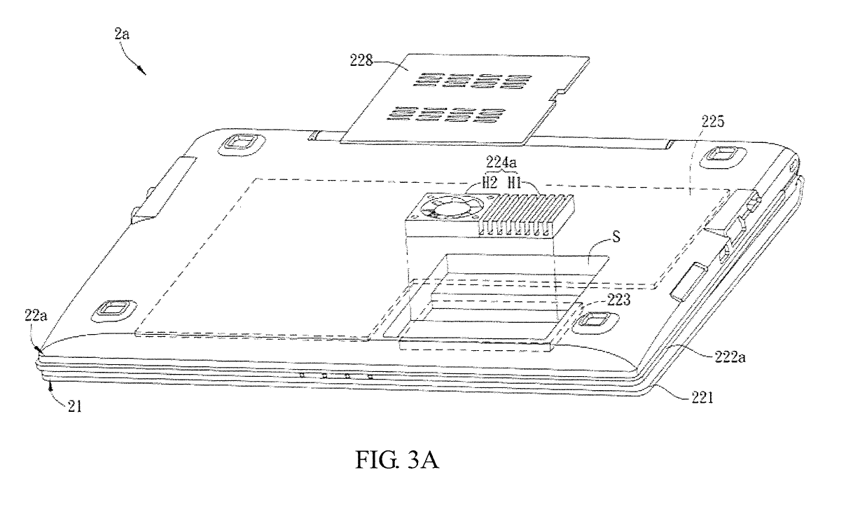

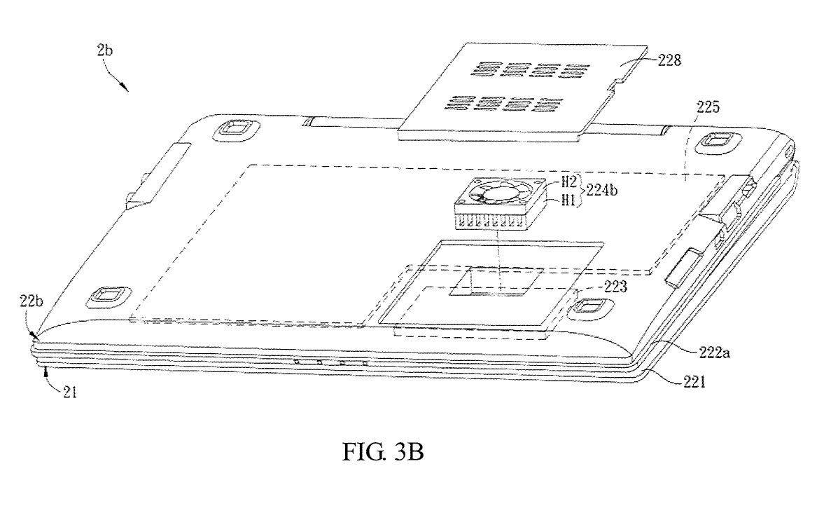

FIG. 3A and FIG. 3B are schematic diagrams showing industrial computers 2a, 2b in different modes according to one preferred embodiment of the invention. Heat dissipation units 224a, 224b of the industrial computers 2a, 2b can further include a first heat dissipation element H1 and a second heat dissipation element H2, and both the first heat dissipation element H1 and the second heat dissipation element H2 are disposed at the other side of the second casings 222a, 222b relative to the storage unit 223 and are located in the containing area S. The first heat dissipation element H1 and the second heat dissipation element H2 may include a heat sink, a heat dissipation fin, a heat dissipation plate, a heat pipe, or a heat dissipation fan, respectively. In the embodiment, the first heat dissipation element H1 and the second heat dissipation element

H2 are a heat dissipation fin and a heat dissipation fan, respectively. However, the invention is not limited thereto.

The first heat dissipation element H1 and the second heat dissipation element H2 may be disposed on the second casings 222a, 222b side by side, as shown in FIG. 3A, or in a stacked mode, as shown in FIG. 3B. Therefore, the heat dissipation of the heat dissipation units 224a, 224b for the storage unit 223 may be improved by disposing the first heat dissipation element H1 and the second heat dissipation element H2.

In addition, the industrial computers 2a, 2b may further include an appearance element 228 disposed on the heat dissipation units 224a, 224b, respectively. Therefore, the appearance element 228 cover the heat dissipation units 224a, 224b respectively to decorate the industrial computers 2a, 2b. Further, the appearance element 228 may be made of a material with a high thermal conductivity, such as metal or an alloy and so on, and thereby the heat generated by the storage unit 223 is effectively dissipated via heat conduction. A plurality of heat dissipation holes may be disposed at the appearance element 228 to improve the heat dissipation.

To sum up, according to the industrial computer in the embodiment of the invention, the heat dissipation unit corresponds to the storage unit, and the heat dissipation unit may include a heat sink, a heat dissipation fin, a heat dissipation plate, heat pipe, a heat dissipation fan, or a combination thereof. Therefore, the heat dissipation of the storage unit is greatly improved by the heat dissipation unit such as a heat dissipation fin or a heat dissipation fan and so on, and the heat dissipation structure such as a heat dissipation hole can be avoided. Thus, the industrial computer in the invention can have the waterproof and dustproof effect to satisfy the industrial standard requirements.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An industrial computer comprising:
a first casing;
a second casing, the second casing and the first casing forming a closed casing, the outside of the second casing having a containing area;
a storage unit disposed in the closed casing, the storage unit contacting the second casing and corresponding to the containing area; and
a heat dissipation unit disposed at the containing area.

2. The industrial computer according to claim 1, wherein the heat dissipation unit comprises a heat sink, a heat dissipation fin, a heat dissipation plate, a heat pipe, or a heat dissipation fan.

3. The industrial computer according to claim 1, wherein the heat dissipation unit comprises a first heat dissipation element and a second heat dissipation element, and both of them are disposed at the containing area.

4. The industrial computer according to claim 3, wherein the first heat dissipation element and the second heat dissipation element are disposed side by side or in a stacked mode.

5. The industrial computer according to claim 3, wherein the first heat dissipation element and the second heat dissipation element comprise a heat sink, a heat dissipation fin, a heat dissipation plate, a heat pipe, or a heat dissipation fan.

6. The industrial computer according to claim 1, further comprising:
a thermal pad connected with the storage unit and the heat dissipation unit.

7. The industrial computer according to claim 1, further comprising:
a plurality of waterproof elements disposed at the second casing.

8. The industrial computer according to claim 1, further comprising:
a plurality of waterproof elements disposed between the second casing and the heat dissipation unit.

9. The industrial computer according to claim 1, further comprising:
a main body unit disposed in the closed casing.

10. The industrial computer according to claim 1, further comprising:
an appearance element assembled at the second casing.
